(19) United States
(12) Patent Application Publication
(10) Pub. No.: US 2005/0047402 A1
(43) Pub. Date: Mar. 3, 2005

(54) End user selectable routing of packet or circuit-switched calls

(76) Inventors: Kevin L. Bostrom, Naperville, IL (US); Gregory A. Freitag, Batavia, IL (US); Richard John Milczarek, Lisle, IL (US); George P. Wilkin, Bolingbrook, IL (US)

Correspondence Address: Reginald J. Hill;Jenner & Block, LLC, One IBM Plaza, Chicago, IL, 60611, US

(21) Appl. No.: 10/651,784

(22) Filed: Aug. 30, 2003

(51) Int. Cl. H04L 12/66

(52) U.S. Cl. 370/354

(57) ABSTRACT

In a communications system (100), a network access device (102) is coupled to a packet network (104) and a circuit-switched network (106). User terminals (112, 130) coupled to the network access device make requests for network access. The network access requests may include data indicating which network is required for a call. This is particularly useful for user terminals that need a certain level of reliability for a call, for example, TTY/TDD devices. A processor (124) in the network access device (102) determines whether each request for network access includes a request for one of the circuit-switched or packet network (202). If the request for network access identifies one of the networks for the call, that network is used for the call, if it is available (208, 212, 214). A fast busy is used as a failure notification to the user terminal (112, 122) if the selected network is not available (210).

### FIELD OF THE INVENTION

The present invention relates generally to telephony services, and in particular, to a method and apparatus that provide an end-user option to route a call over a packet or circuit-switched route to ensure a desired level of quality.

### BACKGROUND OF THE INVENTION

Voice over Internet protocol (VoIP) telephone services are known. Such systems allow voice calls using Internet Protocol (“IP”) networks such as the Internet as an alternative to traditional public-switched telephone networks (“PSTN”). Unlike the PSTN, which is circuit-switched, the Internet is packet-switched. As such, communication on the Internet is accomplished by transmitting and receiving packets of data. In addition to data, each packet contains a destination address to ensure that it is routed correctly. The format of these packets is defined by the IP. One type of allowable data is encoded, digitized voice, termed voice over IP (VoIP). VoIP is voice that is packetized as defined by the Internet protocol, and communicated over the Internet for telephone-like communication. Individual VoIP packets may travel over different network paths to reach the final destination where the packets are reassembled in correct sequence to reconstruct the voice information.

While the virtues of packet networks are widely accepted, packet technology still lacks the reliability and features of circuit-switched networks. More specifically, VoIP network jitter and delay can cause problems for customers using modems, voice encryption devices and TTY/TDD (TeleTYpeWriter/Terminal Device for the Deaf) devices. This leads to dropped or otherwise unusable data or degraded voice calls for customers, which is undesirable.

Many network access devices that couple telephones and other customer premises equipment to networks are currently equipped to use either a packet network connection or a circuit-switched connection. The choice of connection is made solely by the network access device based on certain factors, including routing information, reliability, tariffs and other factors. OIU (Optical Interface Unit) is a feature that is integrated into class 5 local switches, such as the 5ESS by Lucent Technologies. OIU-TDM (OIU-time division multiplexed) permits subscriber traffic within a service provider's local telephone network to travel via a circuit-switched circuit. OIU-IP (OIU-Internet protocol) permits subscriber traffic within a service provider's local telephone network to travel via a packet (IP) circuit. While having a choice is desirable, in certain cases, e.g., TDD/TTY communications, there is a need to ensure a reliable connection. The current offerings do not provide the customer or end user control over the connections used.

Therefore, a need exists for an improved method and apparatus for allowing a customer or end user to select the type of network that will carry a particular call.

### SUMMARY OF THE INVENTION

The need is met and an advance in the art is made by the present invention, which provides a user selectable option that determines whether a call is carried by circuit-switched or packet-based network elements.

In accordance with one aspect of the present invention, a method for transmitting a telephone call over a packet network or a circuit-switched network is provided. According to the method, a request for establishing a telephone call is received from a user terminal. Then the request for the telephone call is decoded to determine whether the request includes a request for a particular network for the call. If the request includes a request for a particular network, a determination is made as to whether that network is available for the call. If the network is available, the call is placed over that network.

In another aspect of the invention, a network access device is provided. The network access device includes a processor, a packet network interface for connecting to a packet network and a circuit-switched network interface for connecting to a circuit-switched network. The processor receives a call request from a user terminal, determines whether the call request includes data indicating a particular network should be used for the call, determines whether the particular network is available, and causes the packet network interface or the circuit-switched network interface to transmit data associated with the call based on the particular network interface selected in the call request.

### BRIEF DESCRIPTION OF THE DRAWINGS

FIG. 1 is a block diagram of a communications system that includes a network access device that alternatively connects to a packet or circuit-switched network based on user input in accordance with the present invention.

FIG. 2 is a flow chart illustrating user selection of a packet or circuit-switched network connection for a call in accordance with the present invention.

### DESCRIPTION OF THE PREFERRED EMBODIMENTS

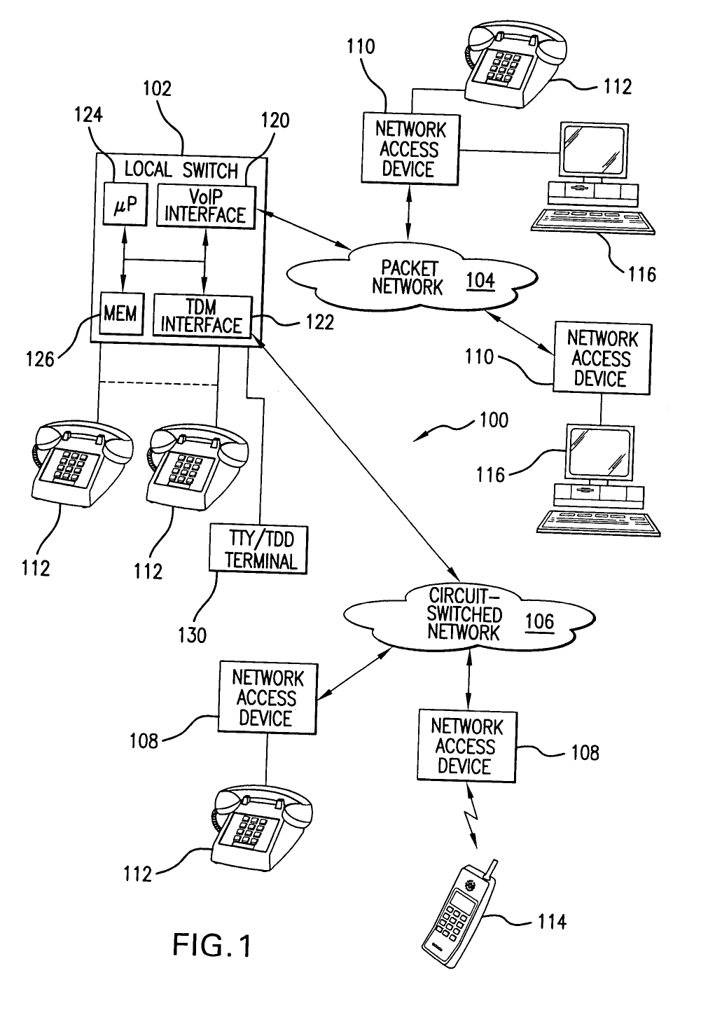

FIG. 1 is a block diagram of a communications system 100 that includes a universal access device 102 that provides a user-selectable option for calls to be routed to a packet or circuit-switched network in accordance with a preferred embodiment of the present invention.

Communication system 100 preferably includes a packet network 104 and a circuit-switched network 106. As is well known in the art, packet network 104 includes transmission paths and network devices for transmitting and receiving packets. An IP (Internet Protocol) network is a preferred packet network. Circuit-switched network 106 includes transmission paths and network devices, such as telecommunications switches, that receive and transmit communications by creating a virtual circuit path. A time-division multiplexed network is a preferred circuit-switched network.

As illustrated in FIG. 1, circuit-switched network access devices 108 are preferably coupled to circuit-switched network 106. Circuit-switched network access devices 108 preferably couple user terminals, such as telephones 112 and wireless access devices 114, to communications system 100, and more specifically, to circuit-switched network 106. Similarly, packet network access devices 110 are preferably coupled to packet network 104. Packet network access devices 110 preferably couple user terminals, such as computers 116 and telephones 112, to communications system 100, and more specifically to packet network 104. Packet network 104 and circuit-switched network 106 may be coupled to each other by a gateway (not shown) or other device as is known in the art.

Network access devices 108 are preferably telephone switches, such as the 5ESS® switch available from Lucent Technologies Inc., Murray Hill, N.J. Alternatively, circuit-switched network access devices 108 are any soft switch, remote terminal product or wireless network access device. Packet network access devices 110 are preferably wireless network access devices, IP, ATM or SONET gateway devices or interface units, such as, for example, OIU-IP or LUCENT soft switches.

Telephones 112 are preferably wired devices that connect to circuit-based access devices. Alternatively, telephones 112 are configured to directly access a packet based network, using VoIP, for example. Wireless access devices 114 are preferably wireless telephones, personal digital assistants and the like.

In accordance with the present invention, universal network access device 102 includes interfaces to packet network 104 and circuit-switched network 106. Network access device 102 preferably couples user terminals, such as telephones 112 and TTY/TDD terminals 130 to either a packet or a circuit-switched network. While the prior art permitted the selection of the network to be accomplished only by universal network access device 102, the present invention permits the selection to be based on user input, as described further below.

Universal network access device 102 is coupled to packet network 104 via a VoIP interface 120. VoIP interface 120 transmits packets to and receives packets from packet network 104. Universal network access device 102 is coupled to circuit-switched network 106 via TDM (time-division multiplexed) interface 122. TDM interface 122 transmits and receives circuit-switched, time division multiplexed communications with circuit-switched network 106. Communications received from packet network 104 by VoIP interface 120 are formatted and sent to the appropriate user terminals. Communications received from circuit-switched network 106 are formatted and sent to the appropriate user terminals. Internal to the universal network access device 102, a processor 124 and memory 126 are coupled together and coupled to the VoIP interface and the TDM interface 122 to control those interfaces. In accordance with the present invention, processor 124 receives input from a user terminal prior to placing a call. The input reflects whether the call should be place over a circuit-switched or packet network.

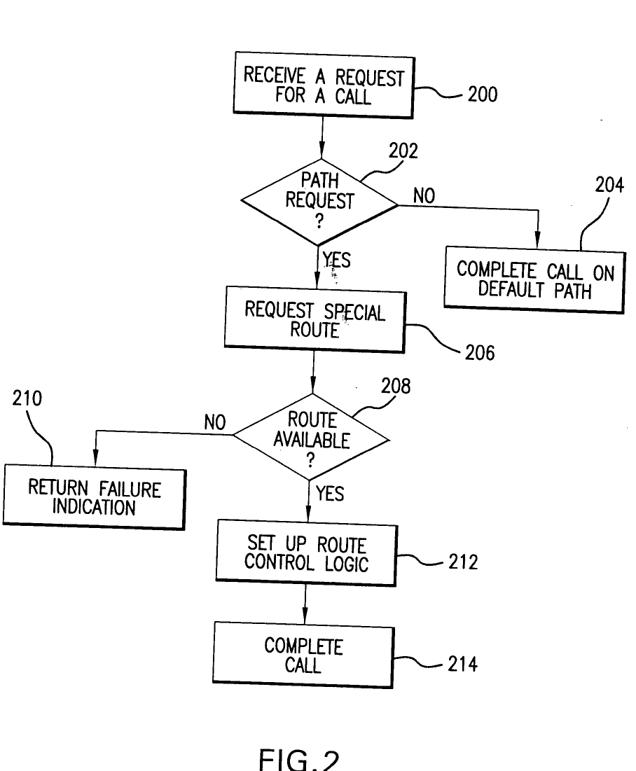

FIG. 2 is a flow diagram illustrating a preferred method for selecting a network connection from a user terminal in accordance with the present invention. The preferred method is described below with reference to the communications system shown in FIG. 1.

First, a call request is received (200). The call request may take many known forms depending on the user terminal and network access device. Typically, for a telephone or TTY/TDD terminal, the call request will include going off-hook in the traditional manner, although the invention is not so limited. In response to the off-hook indication, network access device 102 returns a dial tone to the user terminal, assuming resources are available to initiate the call. After receipt of the dial tone, if the user desires to use a particular network path, i.e., packet or circuit-switched, the user terminal preferably sends digits representative of a request for a data path and the number to be called (202). For example, the user may enter *80 NPA NXX XXXX, where “*80” indicates a circuit-switched connection is desired and “NPA NXX XXXX” is the number to call. Preferably, the default path when no path request is made, is determined by the universal network access device 102. Alternatively, a particular line or trunk group may be selected by a user to always use a particular network path. In the case where no digits representative of a request for a particular path are sent, the default path is taken (204).

On the other hand, where a special path is requested, as determined by the digits sent from the user terminal, processor 124 determines the path requested and determines if resources are available for the route requested (206). This may entail determining whether proper resources are available at the VoIP interface 120 or the TDM interface 122. If the resources required for the route requested are not available (208), then a failure notification is returned (210). Preferably, the failure notification includes a fast busy signal or the like being returned to the user terminal. If however, resources are available for the special path requested (208), then the route control logic is configured (212) such that the call is placed over the path requested (214). Further communication for the call uses the selected network.

Most preferably, measures are taken to insure that the call is transported over the desired network through every node traversed in the network. For example, if the circuit-switched network path is initially selected and the call is routed through intermediary nodes in the network prior to reaching a destination, then those intermediary nodes should continue the call to the next destination using a circuit-switched network. This is preferably accomplished using a switch-to-switch or node-to-node messaging protocol, such as an out-of-band messaging protocol, for example, SS7 signaling or SIP (session initiation protocol) messaging. If a desired network is unavailable to an intermediary node, a failure indication, such as a fast busy signal, is returned to the call originator.

According to the invention, the user is provided the option to determine whether a packet or circuit-switched communications path is taken on a per call basis. This is particularly important for data-based devices, such as TTY/TDD terminals, and calls requiring high reliability.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method for transmitting a telephone call over a packet network or a circuit-switched network, the method comprising the steps of:
receiving a request for the telephone call from a user terminal;
determining whether the request for the telephone call includes data indicating whether a particular network path should be used exclusively for the call;
determining whether the particular network path is available for placing the telephone call; and
transmitting data for the telephone call over the particular network path, if the particular network path is available.

2. The method of claim 1 wherein the data indicating whether a particular network path should be used is derived from digits input at the user terminal.

3. The method of claim 2 further comprising the step of returning a failure indication to the user terminal if the particular network path is not available.

4. The method of claim 1 wherein the particular network is one of a packet network and a circuit-switched network.

5. The method of claim 1 wherein the particular network path is maintained across intermediary nodes traversed by the call by using switch-to-switch messaging.

6. A network access device for use in a communication system, the network access device comprising:
a processor;
a packet network interface for coupling the network device to a packet network;
a circuit-switched network interface for coupling the network access device to a circuit-switched network;
wherein the processor:
receives a call request from a user terminal;
determines whether the call request includes data indicating whether a particular network path should be used exclusively for the call;
determines whether the particular network path is available for placing the call; and
causes one of the packet network interface and the circuit-switched network interface to transmit data for the call over the particular network path, if the particular network path is available.

7. The network access device of claim 6 wherein the data indicating whether a particular network path should be used is derived from digits input at the user terminal.

8. The network access device of claim 7 wherein the processor returns a failure indication to the user terminal if the particular network is not available.
